(19) United States
(12) Patent Application Publication
(10) Pub. No.: US 2016/0337162 A1
(43) Pub. Date: Nov. 17, 2016

(54) APPARATUS AND METHOD FOR HANDLING THE OVERLAP BETWEEN TWO DIFFERENT NETWORKS

(71) Applicant: THOMSON LICENSING, Issy Les-Moulineaux (FR)

(72) Inventors: Tianwen XU, Beijing (CN); Jiancheng LIU, Beijing (CN); Hao XU, Beijing (CN)

(21) Appl. No.: 15/108,314

(22) PCT Filed: Dec. 27, 2013
(86) PCT No.: PCT/CN2013/090735

§ 371 Date: Jun. 26, 2016

(51) Int. Cl. H04L 12/24; H04B 10/27

(52) U.S. Cl. CPC H04L 41/0226; H04B 10/27; H04L 41/0813

(57) ABSTRACT

In the environment where a network attached unit can be controlled by 2 different 1^{st} and 2^{nd} protocols, a method for notifying another protocol of the configuration change of the unit by one protocol. For example, the 1^{st} protocol is OMCI and the 2^{nd} protocol is TR069. The method may comprise the steps of; a) checking whether a 1^{st} message is to change the configuration of the unit or not, if the 1^{st} message is issued by the 1^{st} protocol; b) checking whether the 1^{st} message is common for both 1^{st} and 2^{nd} protocols, if the result of the step a) is yes; c) configuring the unit itself according to the 1^{st} message, if the 1^{st} message is common; d) checking whether the step c) was successful or not; and e) issuing a notifying message by the 2^{nd} protocol, if the step d) was successful.

### TECHNICAL FIELD

The present invention relates generally to a high speed network and, in particular, to Gigabit-capable Passive Optical Networks (GPON).

### BACKGROUND ART

Currently in Gigabit-capable Passive Optical Networks (GPON) field there are two fundamentally different deployment scenarios, one is two-box mode, which is described in FIG. 1 and another is one-box mode, which is described in FIG. 2.

In FIG. 1, a device 110 is an Optical Network Termination (ONT) and a device 120 is a generic Residential GateWay (RGW). These two devices are connected to each other via an xBase-T Ethernet wireline 115. The ONT 110 in this scenario is also called Single Family Unit (SFU), which is a layer 2 device typically managed via ONU (Optical Network Unit) Management and Control Interface (OMCI) only. The Residential GateWay (RGW) 120 usually implements traditional gateway functions such as PPP-Peer, DHCP Client/Server, NA(P)T, IP Routing and Forwarding, Firewalling, TR-069 management and handles all customer premises' interfaces such as WiFi 121, USB (Universal Serial Bus) 122, FXS (Foreign eXchange Station) 123 and xBase-T Ethernet 124. ONT 110 is connected to remote OLT (not shown in FIG. 1) via Fiber 105 and some PCs are connected to RGW 120 via Ethernet 124.

In the two-box scenario described in FIG. 1, the ONT 110 is managed via ONU Management and Control Interface (OMCI), while the User Network Interface (UNI) equipment (for example, RGW 120) is normally managed via TR-069. The demarcation point between these two management domains by OMCI and TR-069 is very clear and it is an Ethernet interface 115. There is no intersection between the OMCI domain and the TR-069 domain because they operate different types of devices.

In FIG. 2, the two functionally separated devices ONT 210 and UNI equipment RGW 220 are physically integrated into one single box 240, which is also known as Home Gateway Unit (HGU). Home Gateway Unit (HGU) is a layer 3 device, which besides terminates the GPON layer and also implements traditional gateway functions, which are mentioned above.

In the one-box scenario, there is no physical interface between ONT 210 and RGW 220. OMCI management domain and TR-069 management domain can control the same HGU. ONT 210 and RGW 220 are connected to each other via Switch DMA Channel 215.

In FIG. 3, OMCI 341 is only used between the Optical Line Termination (OLT) 340 and the Optical Network Termination (ONT) 350. In contrast, TR-069 321 is transparent for the OLT 340 and goes directly from the Auto-Configuration Server (ACS) 320 to the ONT 350 and other equipment in the home network as shown in FIG. 3. Operations Support Systems (OSS) 310 are computer systems used by telecommunications service providers. Element Management System (EMS) 330 consists of systems and applications for managing network elements. Integrated Access Device (IAD) 360 is a customer premise device that provides access to wide area networks and the Internet. Specifically, it aggregates multiple channels of information including voice and data across a single shared access link to a carrier or service provider PoP (Point of Presence). The access link may be a T1 line, a DSL connection, a cable TV (CATV) network, a broadband wireless link, or a Metro-Ethernet connection.

ONU Management and Control Interface (OMCI) standard is developed by International Telecommunication Union Telecommunication Standardization Section (ITU-T), and it is designed to manage ONT including layer 2 and layer 3 services. In theory we can only use OMCI to manage the whole GPON HGU.

By contrast, TR-069 is developed by BroadBand Forum (BBF), and is targeted at management of Broadband Network Termination, to secure auto-configuration of a Customer Premises Equipment (CPE). TR-069 is transparent to the physical and link layer, and mainly focuses on layer 3 services.

As it is well known in this technical field, GPON starts to grow in recent years, by contrast, Digital Subscriber Line (DSL) gateway was widely deployed by telecom operators. In order to manage DSL gateway, most operators purchased Auto-Configuration Server (ACS) to access and manage DSL gateway via TR-069 CPE WAN Management Protocol (CWMP); and the network administrators have already gotten used to manage DSL gateway with the help of ACS.

Nowadays instead of traditional DSL gateway, telecom operators started to deploy GPON gateway Home Gateway Unit (HGU) more and more. Although in theory OMCI can manage the whole HGU, out of habit and in order to protect the operator's existing investments (for example, reuse of ACS) and manage both DSL and GPON gateway uniformly, most operators choose to reuse TR-069 to manage the gateway module of HGU and use OMCI to manage the GPON module of HGU.

In brief, nowadays most operators manage Home Gateway Unit (HGU) via both ONU Management and Control Interface (OMCI) and TR-069 instead of OMCI only.

### SUMMARY OF THE INVENTION

In accordance with one aspect of the present invention, in the environment where a network attached unit can be controlled by 2 different 1^{st} and 2^{nd} protocols, a method for notifying another protocol of the configuration change of the unit by one protocol, the method comprising the steps of a) checking whether a 1^{st} message is to change the configuration of the unit or not, if the 1^{st} message is issued by the 1^{st} protocol, b) checking whether the 1^{st} message is common for both 1^{st} and 2^{nd} protocols, if the result of the step a) is yes, c) configuring the unit itself according to the 1^{st} message, if the 1^{st} message is common, d) checking whether the step c) was successful or not, and e) issuing a notifying message by the 2^{nd} protocol, if the step d) was successful and also may include the steps of f) checking whether a 2nd message is to change the configuration of the unit or not, if the 2nd message is issued by the 2nd protocol, g) checking whether the 2nd message is common for both 1^{st} and 2^{nd} protocols, if the result of the step f) is yes, h) configuring the unit itself according to the 2nd message, if the 2nd message is common, i) checking whether the step h) was successful or not, and j) issuing a notifying message by the 1st protocol, if the step i) was successful and the 1^{st} protocol may be OMCI and the 2^{nd} protocol may be TR-069.

### Technical Problem

As shown in FIG. 5 the overlap 530 between ONU Management and Control Interface (OMCI) domain 510 and TR-069 domain 520 includes layer 3 services, for example, VoIP (Voice over IP) services 530 and so on.

These overlap may introduce some conflicts. Here we take DNS server as an example, OMCI can set DNS server for HGU via attribute “Primary DNS” of ME “IP Host Config Data” and TR-069 can also set DNS server for HGU via IGD parameter “InternetGatewayDevice.WANDevice.1.WANConnectionDevice.1.WANI PConnection.1.DNSServers”.

As shown in FIG. 6, suppose two network administrators, Tom 620 and Jack 630, are separately managing the same Home Gateway Unit (HGU) 610, but both sides don't know each other's existence, i.e., they don't know that the other side administrator is configuring the same HGU simultaneously.

Assume Tom 620 sets IP address of the DNS Server as 1.1.1.1 via OMCI, after that Jack 630 sets IP address of the DNS Server as 2.2.2.2 via TR-069 and then conflict may happen. Which one is set later, which one takes into effect, so for example, in this context in FIG. 6 finally HGU will use 2.2.2.2 as its DNS Server.

But Tom 620 doesn't know this change and still thinks the DNS server is 1.1.1.1, which is apparently no more valid. Tom 620 needs to be notified of this change of DNS Server from 1.1.1.1 to 2.2.2.2. Therefore some measures to notify Tom of the change caused by Jack 630 is necessary to manage this situation correctly.

OMCI provides a mechanism named Attribute Value Change (AVC) notification. So in the case that a concerned attribute value changes from 1.1.1.1 to 2.2.2.2 by Jack 630, the ONT will send an AVC notification to the OLT. Here we can make use of AVC message to notify Tom 620 that someone else changed DNS server 610 via TR-069 650.

Vice versa, if Jack 630 sets IP address of DNS Server 610 as 2.2.2.2 via TR-069 650 first and then Tom 620 sets IP address of DNS Server 610 as 1.1.1.1 via OMCI 640 later, Jack 630 also needs to be notified of this change. TR-069 650 provides an event named “4 VALUE CHANG”. In the case that a concerned attribute value changes, the CPE will send a “4 VALUE CHANGE” event to the ACS. Here “4 VALUE CHANGE” event can be used to notify Jack 630 that someone else changed DNS server 610 via OMCI 640.

Related software can detect this attribute value change by use of the following technique. For example, we can use software polling, by creating a daemon and periodic timers in this daemon, each of which is responsible for a parameter which we concerned, in the callback of timer, comparing the current parameter value with old parameter value, checking whether the corresponding parameter value is changed or not, and if yes, sending notification messages to OLT/ACS.

It is known that such kind of polling technique may consume a lot of CPU resource, and in order to reduce the consumption of CPU, we often set the timer aging timeout as 10˜30 seconds typically, but not limited to the timeout value and it depends on the system configuration. In this case, Tom 620 and Jack 630 can see the DNS server change notification after 10˜30 seconds after the change happens.

In addition, software polling technique can only detect that one parameter value changes but doesn't know who changes this value, for example, OMCI or TR-069. In this context, both OMCI and TR-069 are possible to change the value. Usually it has to send two notification messages, one is AVC to OLT and another is “4 VALUE CHANGE” event to ACS, in which there is a redundant message. For example, if TR-069 changes a parameter value, we only need to send an OMCI's AVC notification to OLT, and don't need to send “4 VALUE CHANGE” event to ACS because TR-069 already knew this change triggered by itself. This will confuse ACS, if we send the redundant message to ACS.

The ITU-T OMCI Recommendation G.988 standard defines a Management Entity (ME) “Generic Status Portal (GSP)”, which provides a way for the OLT to discover the status and configuration information of a non-OMCI management domain within an ONT. This Management Entity (ME) contains two table attributes, one is status document table and another is configuration document table. The OLT reads these tables to obtain an XML representation of the non-OMCI management domain status and configuration. Whenever the text in this table changes, the ONT issues an AVC to the OLT. In the case described in FIG. 6, when Jack 630 changes DNS server 610, besides OMCI sends DNS server 610 AVC to OLT, also need to sends GSP “configuration document table” AVC to OLT.

It is known that both OMCI and TR-069 are necessary to manage GPON HGU, and the coexistence of OMCI and TR-069 may cause conflict issue.

OMCI needs to know whether TR-069 changes their common parameters or not. ITU-T G984.4 standard provides AVC message, which can be used to manage this situation.

Vice versa, TR-069 also needs to know whether OMCI changes their common parameters. The BroadBand Forum (BBF) TR-069 provides “4 VALUE CHANG” event to handle it.

The traditional polling mechanism (for example, timer aging timeout is 10˜30 seconds) can't send notification to OLT/ACS timely, and can't know the source of value change so that it has to send notifications to both sides, which will confuse OLT/ACS.

In this context, GPON HGU vendors need to find a more effective way for timely detecting change of parameter value and avoiding unnecessary notification.

### Solution to Problem

To achieve instant and effective value change notification and best effort saving for CPU, to avoid unnecessary notification, we use a specific solution to handle the common parameters of both ONU Management and Control Interface (OMCI) and TR-069 instead of conventional software polling mechanism.

When receiving OMCI Set, Create or Delete message, which may change the attribute value, it checks whether that attribute is a common parameter or not, if yes, and if configure successfully, send a TR-069 “4 VALUE CHANG” event to ACS.

When receiving TR-069 SetParameterValues, SetParameterAttributes, AddObject or DeleteObject message, which may change the parameter value, it checks whether that parameter is a common parameter or not, if yes, and if configure successfully, send an OMCI AVC message to OLT.

### BRIEF DESCRIPTION OF THE DRAWINGS

These and other aspects, features and advantages of the present invention will become apparent from the following description in connection with the accompanying drawings in which:

FIG. 1 is a block diagram of two-box mode;

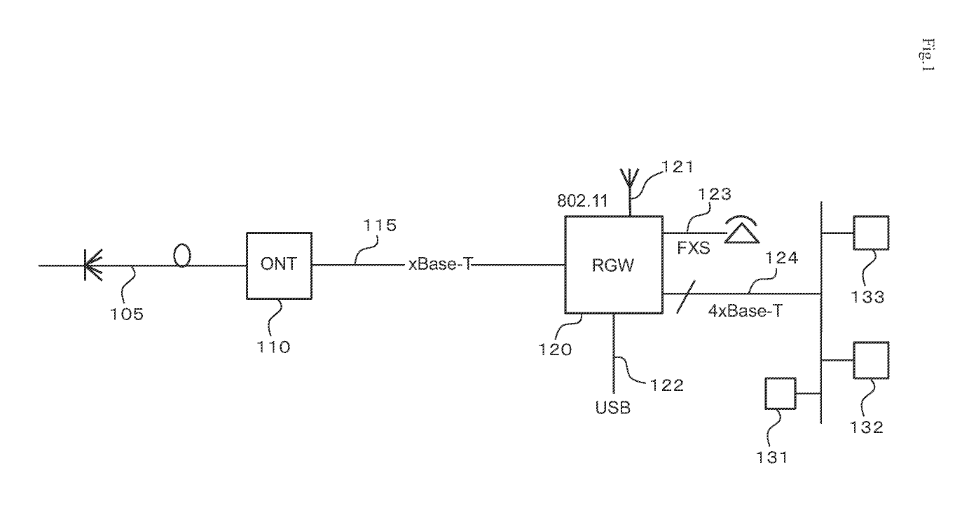

FIG. 2 is a block diagram of one-box mode;

FIG. 3 is a diagram to illustrate the OMCI and TR-069 management framework;

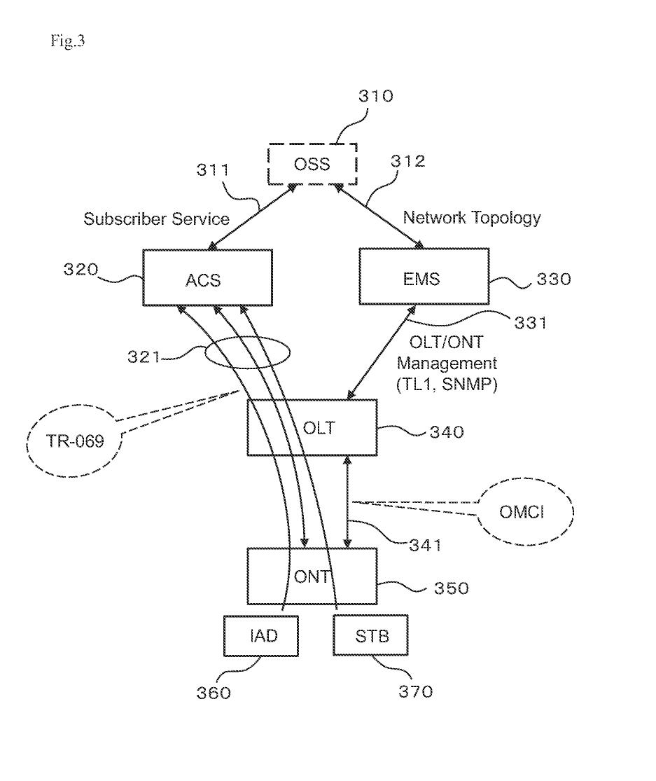

FIG. 4 is a block diagram to coexistence of OMCI and TR-069 in GPON HGU in accordance with an embodiment of the present invention;

FIG. 5 is a Venn diagram to illustrate the overlap between OMCI and TR-069;

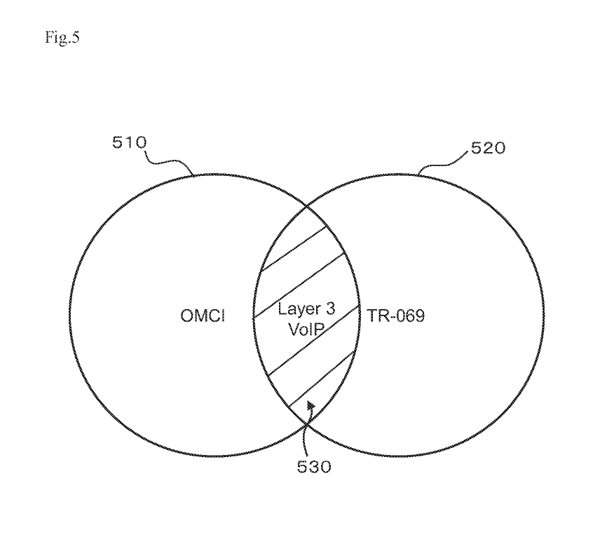

FIG. 6 is a network diagram to illustrate the configuration of DNS Server via OMCI and TR-069;

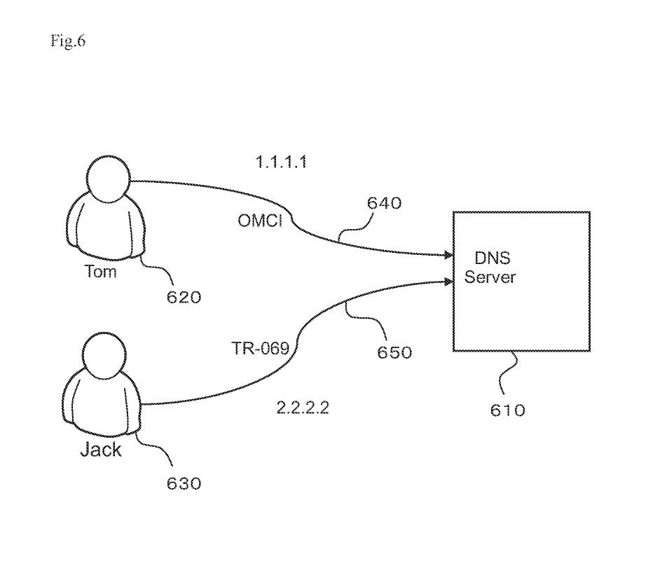

FIG. 7 is a functional block diagram to illustrate the process of setting by OMCI and notified to TR-069 in accordance with an embodiment of the present invention;

FIG. 8 is a functional block diagram to illustrate the process of setting by TR-069 and notified to OMCI in accordance with an embodiment of the present invention; and

FIG. 9 is a flowchart to illustrate the process of software in accordance with an embodiment of the present invention.

### DESCRIPTION OF EMBODIMENT

In the following description, various aspects of an embodiment of the present invention will be described. For the purpose of explanation, specific configurations and details are set forth in order to provide a thorough understanding. However, it will also be apparent to one skilled in the art that the present invention may be implemented without the specific details present herein.

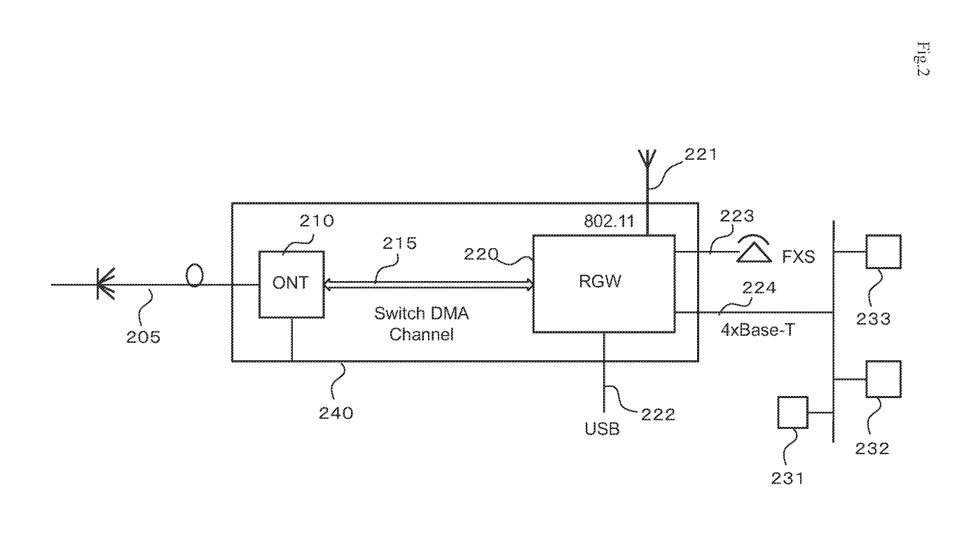

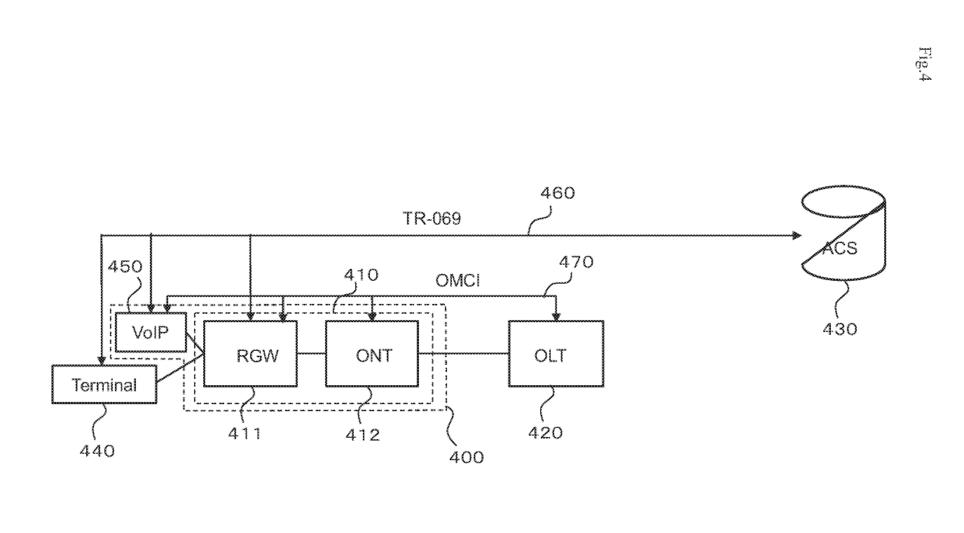

FIG. 4 describes the relationship between OMCI 470 and TR-069 460 toward Home Gateway Unit (HGU) 400. In FIG. 4 the one-box scenario, which is described in FIG. 2 is implemented and RGW 411 and ONT 412 are physically integrated into one device, HGU 400.

OMCI protocol 470 can manage Optical Network Termination (ONT) 412, Residential GateWay (RGW) 411 and VoIP client 450, which are integrated in the Home Gateway Unit (HGU) 400. TR-069 protocol 460 can configure Residential GateWay (RGW) 411, VoIP client 450 and the terminals 440 connected to RGW 411 (e.g., IP STB (Set-Top Box)). It can be seen that TR-069 460 can overlap OMCI 470 domain in the configuration and management of RGW 411 and VoIP client 450.

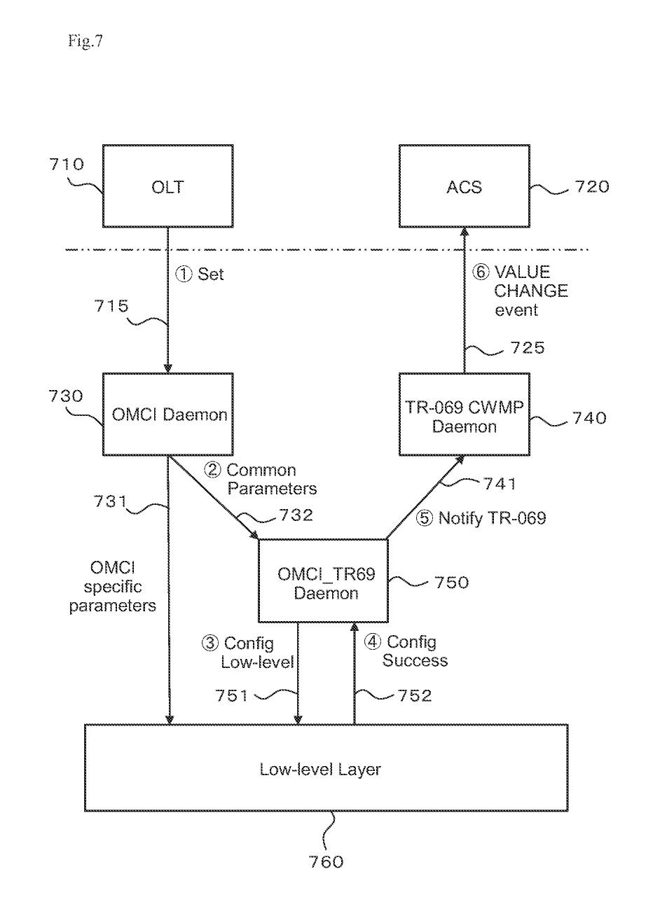

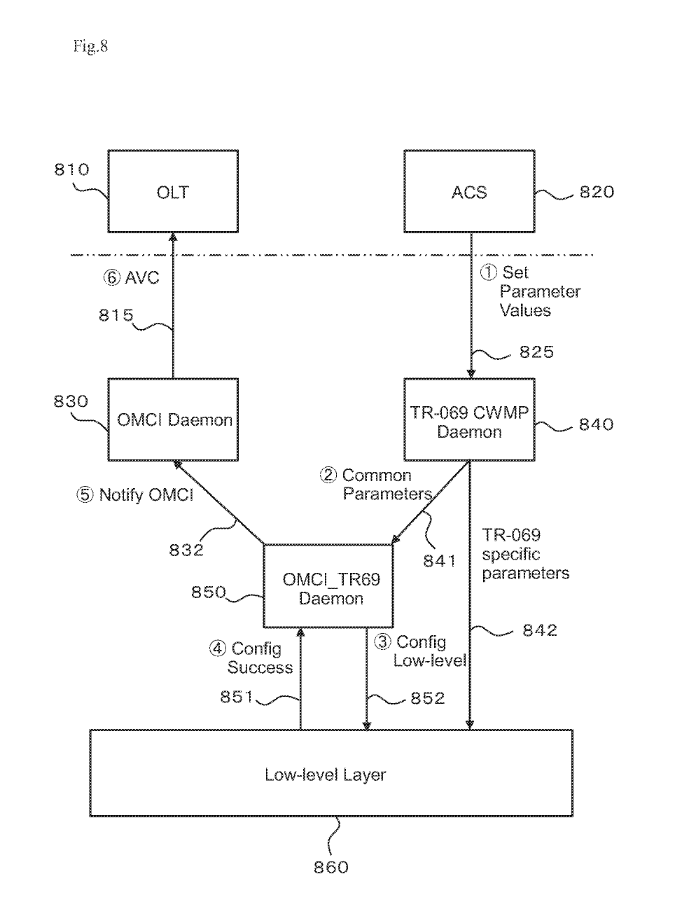

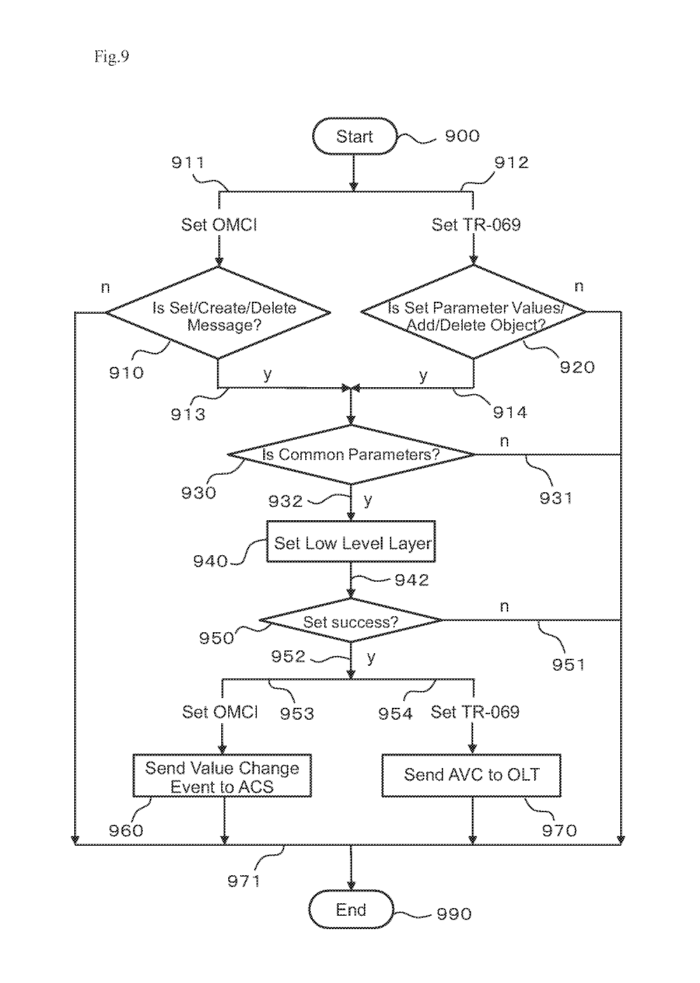

Regarding the specific solution to handle the common parameters managed by both OMCI and TR-069, its software frame in accordance with an embodiment of the present invention is shown in FIG. 7 and FIG. 8 and the workflow of FIG. 7 and FIG. 8 is described in FIG. 9.

FIG. 7 is a block diagram to illustrate the flow of the software of the present invention, if OLT changes the parameter of DNS Server.

OLT 710 issues an OMCI Set, Create or Delete message to ONT (Step 715) and then ONT receives the message sent by OLT. ONT forwards the message to OMCI daemon 730 to handle it. OMCI daemon 730 checks if this parameter is a Common Parameter between OMCI and TR-069 (Step 732). If yes, OMCI daemon forwards this message to OMCI_TR69 daemon 750. If no, OMCI daemon 730 forwards the message to Low-level Layer 760 directly.

For Common Parameter, OMCI_TR69 daemon 750 configures different Low-level module per parameter type (Step 751).

Low-level Layer 760 configures itself, and then Low-level Layer 760 sends configure result back to OMCI_TR69 Daemon 750 (Step 752).

If configure succeeds, OMCI_TR69 daemon 750 notifies TR-069 CWMP daemon 740 that OMCI changed a common parameter successfully (Step 741).

TR-069 CWMP daemon 740 sends a “4 VALUE CHANGE” event to ACS 720, so that TR-069 administrator can be aware of this change (Step 725).

In contrast to FIG. 7, FIG. 8 is a block diagram to illustrate the flow of the software of the present invention, if ACS changes the parameter of DNS Server.

ACS 820 issues a SetParameterValues, SetParameterAttributes, AddObject or DeleteObject message 825 to CPE and then CPE receives the message sent by ACS. CPE forwards the message to TR-069 CWMP daemon 840 to handle it (Step 825).

TR-069 CWMP daemon 840 checks if this parameter is a Common Parameter between TR-069 and OMCI. If yes, TR-069 CWMP daemon 840 forwards this message to OMCI_TR69 daemon 850. If no, TR-069 CWMP daemon forwards the message to Low-level Layer 860 directly (Step 842).

For Common Parameters, OMCI_TR69 daemon 850 configures different Low-level module per parameter type (Step 852).

Low-level Layer 860 configures itself and then sends configure result back to OMCI_TR69 Daemon 850 (Step 851).

If configure succeeds, OMCI_TR69 daemon 850 notifies OMCI daemon 830 that TR-069 changed a common parameter successfully (Step 832).

OMCI daemon 830 sends two AVC messages to OLT, so that OMCI administrator would be aware of this change (Step 815). Please note that in this context the two AVC messages are the corresponding AVC which triggered by TR-069 and GSP “configuration document table” AVC.

FIG. 9 is a flowchart of functional software diagrams of FIG. 7 and FIG. 8.

The process of the preferred embodiment starts from START 900. If OLT issues OMCI massage, Step 911 is selected and in contrast, if ACS issues TR-069 message, Step 912 is selected.

If OMCI message was issued, the content of the message is checked in Step 910, and if OMCI message is one of OMCI Set, Create or Delete messages, the control goes to Step 930 (Step 913). If OMCI message is not OMCI Set, Create nor Delete message, the flow goes to END 990 (Step 971).

If TR-069 message was issued, the content of the message is checked in Step 920, and if TR-069 message is one of TR-069 SetParameterValues, SetParameterAttributes, AddObject or DeleteObject messages, the flow goes to Step 930 (Step 914). If TR-069 message is not TR-069 SetParameterValues, SetParameterAttributes, AddObject nor DeleteObject message, the control goes to END 990.

In Step 930, whether the issued parameter is common between OMCI and TR-069 or not is examined and if the parameter is common parameter and then the control goes to Step 940. If the parameter is not common parameter and then the control goes to END 990 (Step 931).

In Step 940, the Lower-level Layer configures itself and then the control goes to Step 950 (Step 942).

In Step 950, whether the set of the configuration was successfully or not was checked and if the set of the configuration was successful, the control goes to Step 960 for OMCI message and to Step 970 for TR-069 message (Step 953 and 954).

In Step 960, Value change event is sent to ACS and then the control goes to END 990.

In Step 970 AVC is sent to OLT and then the control goes to END 990.

In above paragraphs we already introduced the idea of instant and effective notification reporting, regarding the detailed software processing flow, please refer to FIG. 9:

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention.

1. In the environment where a network attached unit can be controlled by 2 different first and second protocols, a method for notifying the other protocol of the configuration change of the unit by one protocol, the method comprising the steps of;
a) checking whether a message is to change the configuration of the unit or not, if the message is issued by one of the first and second protocols;
b) checking whether the message is common for both first and second protocols or not, if the result of the step a) is yes;
c) configuring the unit itself according to the message, if the message is common, if the result of the step b) is yes;
d) checking whether the step c) was successful or not; and
e) issuing a notifying message to the other protocol, if the step d) was successful.

2. (canceled)

3. The method as in claim 1, wherein the first protocol is one of OMCI and TR-069, and the second protocol is the other.

4. A device can be in the environment where a network attached unit can be controlled by first and second protocols, comprising a processor for;
receiving a message according to one of the first and second protocols,
wherein the message is intended to change the configuration of the network attached unit, and is a common for both the first and second protocols,
configuring the unit according to the message;
if the configuration was successful, issuing a notifying message to the other protocol.

5. (canceled)

6. The device according to claim 4, wherein the first protocol is one of OMCI and TR-069, and the second protocol is the other.
